(19) United States
(12) Patent Application Publication
(10) Pub. No.: US 2017/0244304 A1
(43) Pub. Date: Aug. 24, 2017

(54) SYSTEMS AND METHODS FOR COOLING STATOR WINDINGS BY AN INTERNAL FAN IN A BRUSHLESS ALTERNATOR

(71) Applicant: Prestolite Electric, Inc., Novi, MI (US)

(72) Inventors: Andrew Cawse, Jukskei Park - Randburg (ZA); Robert D. Hall, Berkey, OH (US); Michael J. Hanchett, Lapeer, MI (US)

(21) Appl. No.: 15/438,993

(22) Filed: Feb. 22, 2017

Related U.S. Application Data
(60) Provisional application No. 62/298,028, filed on Feb. 22, 2016.

(51) Int. Cl. H02K 9/06; H02K 7/14; H02K 5/20

(52) U.S. Cl. CPC H02K 9/06; H02K 5/20; H02K 7/14

(57) ABSTRACT

A brushless alternator includes a drive end, a rear end, a rotor assembly, stator windings, and an internal fan. The rotor assembly has a first diameter. The rotor assembly includes a hollow pole and a solid pole. The stator windings surround the rotor assembly. The internal fan has a second diameter that is larger than the first diameter of the rotor assembly. The internal fan may be attached to the hollow pole of the rotor assembly. The hollow pole may be toward the drive end and the solid pole may be toward the rear end. The internal fan may include an outer portion shaped to direct air at the stator windings. The outer portion of the internal fan may include one or more of a curved or angled surface to direct the air. The internal fan may provide an axial flow of the air directed to the stator windings.

### CROSS-REFERENCE TO RELATED APPLICATIONS/INCORPORATION BY REFERENCE

The present application claims priority under 35 U.S.C. §119(e) to provisional application Ser. No. 62/298,028, filed on Feb. 22, 2016. The above referenced provisional application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD

Certain embodiments relate to systems and methods for cooling stator windings in an alternator. More specifically, certain embodiments provide an internal fan of a brushless alternator. The internal fan may have a diameter that is larger than the diameter of a rotor assembly of the alternator to allow space to direct air toward the stator windings and to increase air flow. The internal fan comprises a curved or angled outlet section to direct air axially to the stator windings of the alternator.

### BACKGROUND

Alternators are electromechanical devices that convert mechanical energy to alternating current. FIG. 1 is a vertical cross-sectional view, taken along the longitudinal axis of a rotor assembly shaft 11, of an exemplary brushless alternator 1 as is known in the art. Referring to FIG. 1, the exemplary brushless alternator 1 may comprise, as an example, a drive end 2, a rear end 4, sides 6, a drive end housing 70, a rotor assembly 10, stator windings 20, rectifier assembly 30, a regulator 40, an external drive end fan 50, and a conventional main air flow path 80, among other things.

The regulator 40 is an electronic component disposed at the rear end 4 of the alternator 1. The regulator 40 controls the alternator 1 output by monitoring the battery (not shown) and voltages of the stator windings 20. The regulator 40 adjusts the amount of rotor field current to control the alternator 1 output based on the measured voltages. The rotor assembly 10 may comprise a shaft 11, drive end rotor poles 12, rear end rotor poles 13, a bobbin core 15, and a field coil 14, for example. The field coil 14 may be wound over the bobbin core 15 that may be a part of the shaft 11. The drive end rotor poles 12 and rear end rotor poles 13 may surround the field coil 14. Typically, the drive end rotor poles 12 are solid poles and the rear end rotor poles 13 are hollow poles. The shaft 11 may be connected with, for instance, a pulley, not shown, that may be driven by the engine of a motor vehicle, also not shown. The field coil 14 creates a magnetic field and spinning of the drive end rotor poles 12 and rear end rotor poles 13 with the shaft 11 creates an alternating magnetic field that induces an alternating voltage into the stator windings 20. The stator windings 20 output an AC voltage that is converted to a DC voltage by the rectifier assembly 30. The DC voltage is outputted by the alternator 1 to the battery (not shown).

During operation, various components of the alternator 1, such as the rectifier assembly 30, regulator 40, and stator windings 20, generate heat that may limit the effectiveness of the components and cause them to break down more quickly over time. Accordingly, current alternators 1 may include an external drive end fan 50 to promote air circulation. The external drive end fan 50 may be mounted on and rotate with the rotor shaft 11 outside of the alternator 1 adjacent to the drive end housing 70. Rotation of the external drive end fan 50 pulls ambient temperature air in from the rear end 4 of the alternator 1, along a conventional external drive end fan air flow path 80, out of the drive end housing 70 at the drive end 2 of the alternator 1, and expels the air out the sides of the external drive end fan 50.

Current conventional main air flow paths 80 in brushless alternators 1 have limited effectiveness cooling the stator windings 20. For example, the air in current conventional main air flow paths 80 is not directed at the stator windings 20. As another example, the ambient temperature air 80 that is drawn into the alternator 1 at the rear end 4 is pre-heated by the rectifiers 30 and regulator 40 prior to passing adjacent to the stator windings 20. Furthermore, the air flow 80 passing through the alternator 1 from the rear end 4 to the drive end 2 is throttled. Additionally, the conventional main air flow paths 80 are created by the external drive end fan 50 pulling air through the alternator 1, which is less effective than blowing air. The ineffective cooling of the stator windings 20 may reduce the performance and life of the alternator 1. Moreover, external fans 50 attached to alternators 1 may not be safe.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

Systems and methods for cooling stator windings by an internal fan in an alternator are provided, substantially as shown in and/or described in connection with at least one of the figures, as set forth more completely in the claims.

These and other advantages, aspects and novel features of the present disclosure, as well as details of illustrated embodiments, will be more fully understood from the following description and drawings.

### BRIEF DESCRIPTION OF SEVERAL VIEWS OF THE DRAWINGS

FIG. 1 is a vertical cross-sectional view, taken along the longitudinal axis of a rotor assembly shaft, of an exemplary brushless alternator as is known in the art.

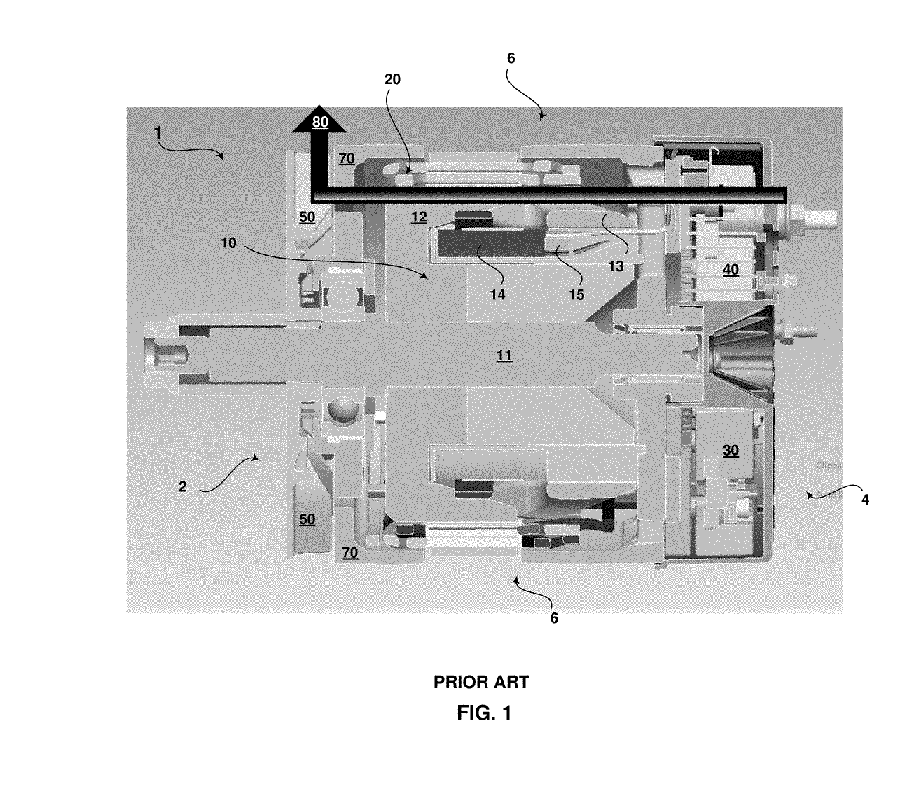

FIG. 2 is a vertical cross-sectional view, taken along the longitudinal axis of a rotor assembly shaft, of an exemplary brushless alternator comprising an internal fan operable to cool stator windings in accordance with various embodiments.

FIG. 3 is a perspective, vertical cross-sectional view, taken along the longitudinal axis of a rotor assembly shaft, of an exemplary brushless alternator comprising an internal fan operable to cool stator windings in accordance with various embodiments.

FIG. 4 is a vertical cross-sectional view, taken along the longitudinal axis of a rotor assembly shaft, of an exemplary brushless alternator comprising an internal fan operable to cool stator windings in accordance with various embodiments.

FIG. 5 is a vertical cross-sectional view, taken along the longitudinal axis of a rotor assembly shaft, of an exemplary brushless alternator comprising an internal fan operable to cool stator windings in accordance with various embodiments.

FIG. 6 is a perspective, vertical cross-sectional view, taken along the longitudinal axis of a rotor assembly shaft, of an exemplary brushless alternator comprising an internal fan operable to cool stator windings in accordance with various embodiments.

FIG. 7 is a front perspective view of a portion of an exemplary brushless alternator comprising an internal fan operable to cool stator windings (not shown) in accordance with various embodiments.

FIG. 8 is a rear perspective view of a portion of an exemplary brushless alternator comprising an internal fan operable to cool stator windings (not shown) in accordance with various embodiments.

FIG. 9 is a vertical cross-sectional view, taken along the longitudinal axis of a rotor assembly shaft, of a portion of an exemplary brushless alternator comprising an internal fan operable to cool stator windings (not shown) in accordance with various embodiments.

FIG. 10 is a rear perspective, vertical cross-sectional view, taken along the longitudinal axis of a rotor assembly shaft, of a portion of an exemplary brushless alternator comprising an internal fan operable to cool stator windings (not shown) in accordance with various embodiments.

FIG. 11 is a rear perspective view of a portion of an exemplary brushless alternator comprising an internal fan operable to cool stator windings in accordance with various embodiments.

FIG. 12 is a rear perspective, vertical cross-sectional view, taken along the longitudinal axis of a rotor assembly shaft, of a portion of an exemplary brushless alternator comprising an internal fan operable to cool stator windings in accordance with various embodiments.

FIG. 13 is a vertical cross-sectional view, taken along the longitudinal axis of a rotor assembly shaft, of a portion of an exemplary brushless alternator comprising an internal fan operable to cool stator windings in accordance with various embodiments.

FIG. 14 is a front perspective, vertical cross-sectional view, taken along the longitudinal axis of a rotor assembly shaft, of a portion of an exemplary brushless alternator comprising an internal fan operable to cool stator windings in accordance with various embodiments.

FIG. 15 is a rear perspective, vertical cross-sectional view, taken along the longitudinal axis of a rotor assembly shaft, of a portion of an exemplary brushless alternator comprising an internal fan operable to cool stator windings in accordance with various embodiments.

FIG. 16 is a partially exploded perspective view of a portion of an exemplary brushless alternator comprising an internal fan operable to cool stator windings (not shown) in accordance with various embodiments.

FIG. 17 is a partially exploded perspective view of an exemplary brushless alternator comprising an internal fan operable to cool stator windings in accordance with various embodiments.

FIG. 18 illustrates a front end elevational view of an exemplary internal fan in accordance with various embodiments.

FIG. 19 illustrates a vertical cross-sectional view of an exemplary internal fan, taken along the longitudinal axis of the internal fan, in accordance with various embodiments.

FIG. 20 illustrates a rear end elevational view of an exemplary internal fan in accordance with various embodiments.

FIG. 21 illustrates a front end perspective view of an exemplary internal fan in accordance with various embodiments.

FIG. 22 illustrates a rear end perspective view of an exemplary internal fan in accordance with various embodiments.

FIG. 23 is a flow diagram that illustrates exemplary steps for cooling stator windings with an internal fan of a brushless alternator in accordance with various embodiments.

### DETAILED DESCRIPTION

Certain embodiments may be found in systems 150 and methods 200 for cooling stator windings 120 in an alternator 100. More specifically, certain embodiments provide an internal fan 150 of a brushless alternator 100. The internal fan 150 may have a diameter that is larger than the diameter of a rotor assembly 110 of the alternator 100 to allow space to direct air toward the stator windings 120 and to increase air flow 190. The internal fan 150 and/or a separate part adjacent to the internal fan 150 may comprise a curved or angled outlet section 152, 154 to direct air 190 to the stator windings 120 of the brushless alternator 100. In various embodiments, the internal fan 150 may by a centrifugal fan and the curved or angled outlet section 152, 154 provides an axial flow of air 190 as opposed to a radial flow.

As used herein, an element recited in the singular and proceeded with the word “a” or “an” should be understood as not excluding the plural of the elements, unless such exclusion is explicitly stated. Furthermore, references to “an embodiment,” “one embodiment,” “a representative embodiment,” “an exemplary embodiment,” “various embodiments,” “certain embodiments,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Although certain embodiments in the description and figures may be shown with brushless alternators 100, for example, unless so claimed, the scope of various aspects of the present disclosure should not be limited to brushless alternators 100 and may additionally and/or alternatively be applicable to brush-type alternators, or any suitable alternator. Moreover, although certain embodiments in the description and figures may show the internal fan 150 having the diameter that is larger than the diameter of the rotor assembly 110 positioned at a drive end 102 of the alternator 100, for example, unless so claimed, the scope of various aspects of the present disclosure should not be limited to such a configuration and the internal fan 150 may additionally and/or alternatively be positioned toward the rear end 104 by, for example, reversing the field coil 114 and hollow pole 112. Furthermore, although certain embodiments in the description and figures may be shown with the curved or angled outlet section 152, 154 being a part of the internal fan 150, for example, unless so claimed, the scope of various aspects of the present disclosure should not be limited to such a configuration and may additionally and/or alternatively be separate components where the curved or angled outlet section is located adjacent to the internal fan 150, such as attached to or integrated with an internal portion of the alternator housing 170, 171 for example.

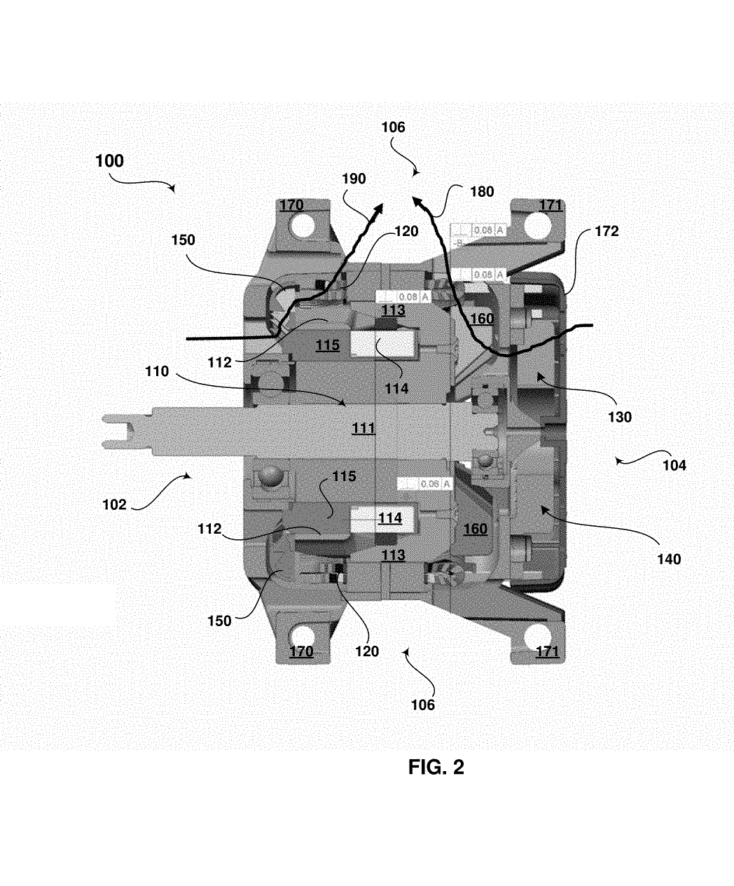

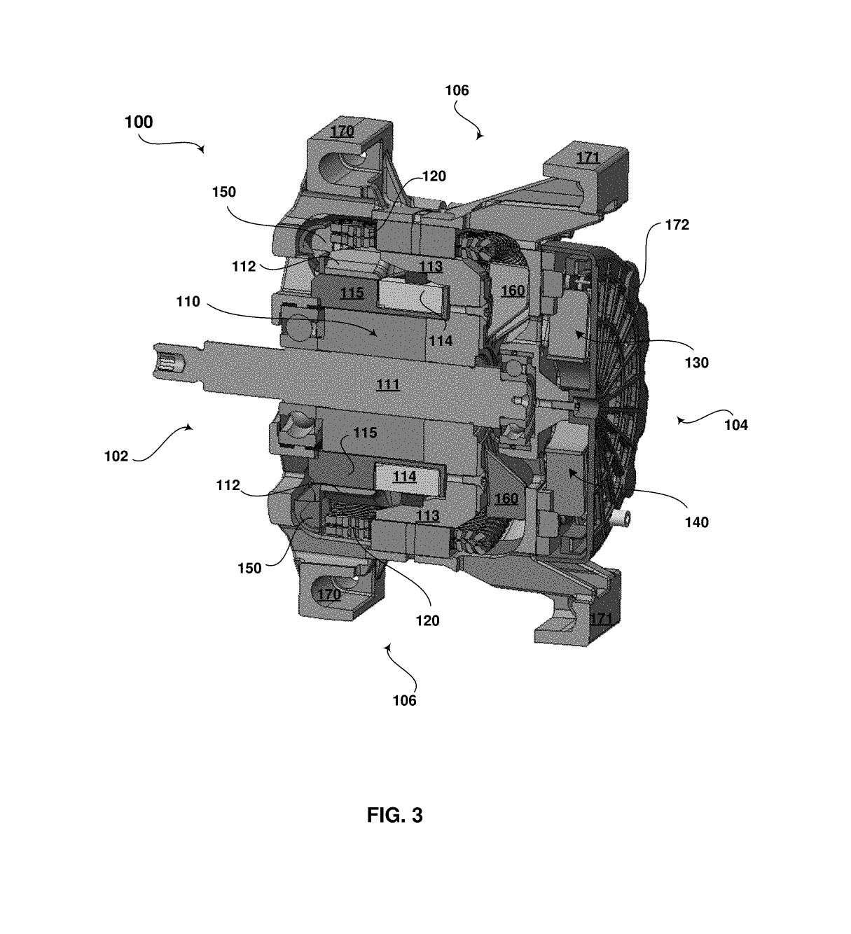

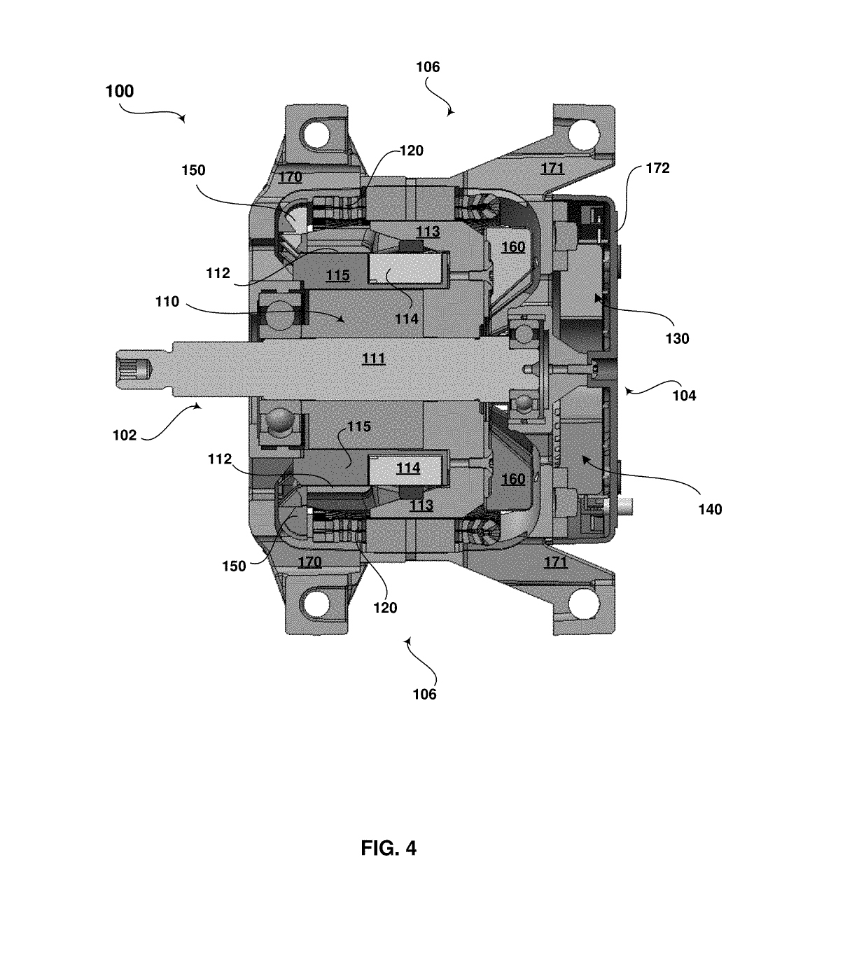

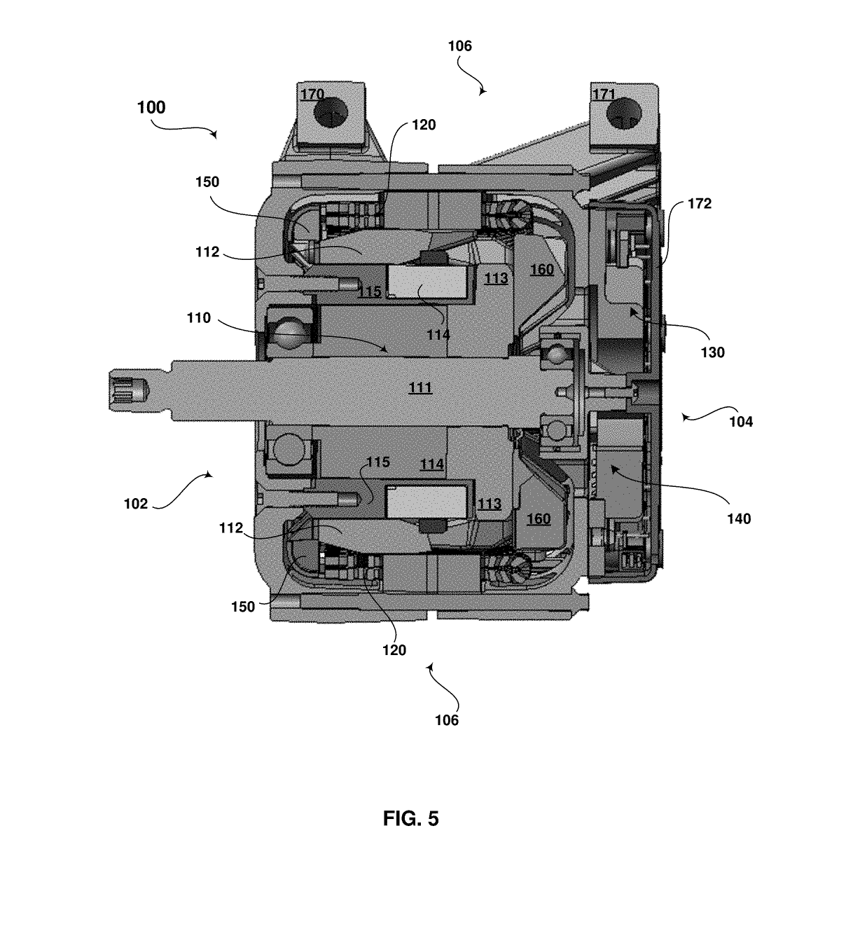

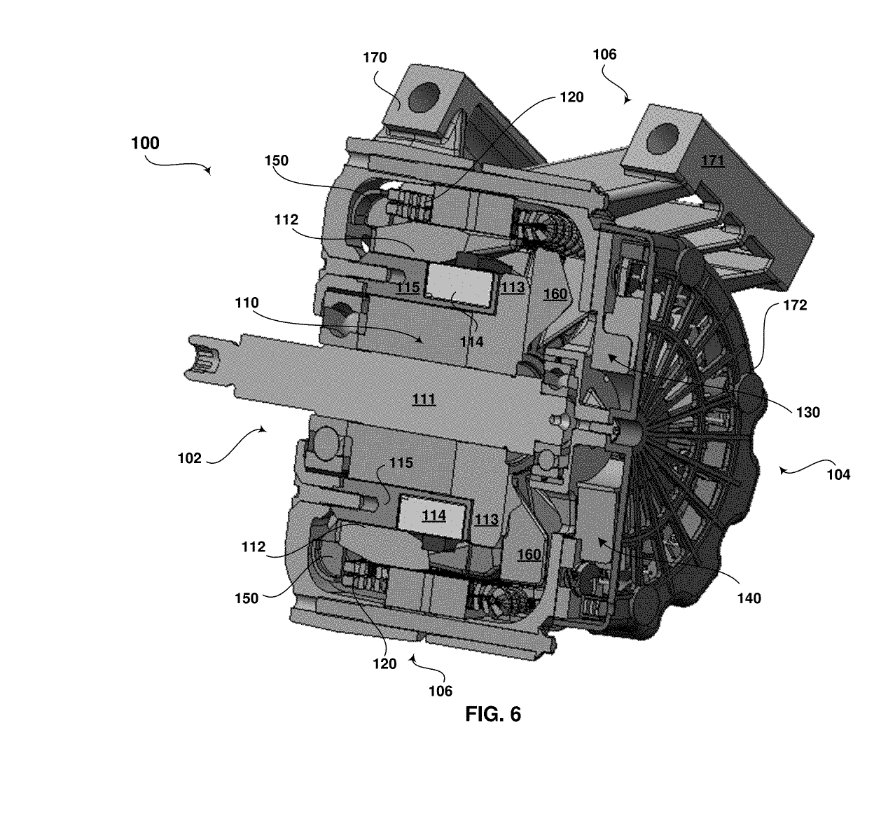

FIGS. 2, 4, and 5 are vertical cross-sectional views, taken along the longitudinal axis of a rotor assembly shaft 111, of an exemplary brushless alternator 100 comprising an internal fan 150 operable to cool stator windings 120 in accordance with various embodiments. FIGS. 3 and 6 are perspective, vertical cross-sectional views, taken along the longitudinal axis of a rotor assembly shaft 111, of an exemplary brushless alternator 100 comprising an internal fan 150 operable to cool stator windings 120 in accordance with various embodiments. Referring to FIGS. 2-6, the exemplary alternator 100 may comprise a drive end 102, a rear end 104, sides 106, a rotor assembly 110, stator windings 120, a rectifier assembly 130, a regulator 140, an internal drive end fan 150, an internal rear end fan 160, housing(s) 170, 171, and a cover assembly 172, among other things. The rotor assembly 110, stator windings 120, and internal fans 150, 160 may be disposed within drive end housing 170 and/or rear end housing 171. The rectifier assembly 130 and regulator 140 may be disposed within the cover assembly 172 adjacent the rear end housing 171 at the rear end 103 of the alternator 100.

The rotor assembly 110 may comprise a rotor shaft 111, drive end rotor poles 112, rear end rotor poles 113, a field coil 114, and a bobbin core 115, among other things. The field coil 114 may be wound over the bobbin core 115 that may surround the rotor shaft 111. The rotor shaft 111 may be connected with, for instance, a pulley that may be driven by the engine of a motor vehicle, not shown. The rotor shaft 111 rotates to spin the drive end rotor poles 112 and rear end rotor poles 113 surrounding the stationary field coil 114 to provide an alternating magnetic field that induces an alternating voltage at the stator windings 120. For example, the rotor poles 112, 113 can be a claw-pole configuration having a number of alternating pole fingers that provides a circumferential surface facing the stator windings 120. The pole fingers may alternate between a drive end pole 112 and a rear end pole 113. In an exemplary embodiment, the drive end poles 112 may be hollow poles and the rear end poles 113 may be solid poles. In various embodiments, the rotor assembly 110 may be supported at the drive end housing 170 and the rear end housing 171 by bearings.

The stator windings 120 are a stationary component surrounding the rotor assembly 110. The drive end rotor poles 112, rear end rotor poles 113, and field coil 114 of the rotor assembly 110 induce an alternating voltage into the stator windings 120. The regulator 140 may be disposed in the cover assembly 172 and controls the alternator 100 output by monitoring the battery (not shown) and the voltages of the stator windings 120. The regulator 140 adjusts the amount of rotor field current to control the alternator 100 output based on the measured voltages. The rectifier assembly 130 may be disposed in the cover assembly 172 and converts the AC voltage provided by the stator windings 120 to a DC voltage outputted to a battery, not shown.

The internal rear end fan 160 may be disposed within the rear end housing 171 and coupled to the solid and/or rear end poles 113 of the rotor assembly 110. Accordingly, the internal rear end fan 160 may rotate with the spinning of the solid and/or rear end poles 113. The internal rear end fan 160 may provide a rear end fan air flow 180 that cools the electronics 130, 140 and is expelled out the side 106 of the alternator 100. For example, the internal rear end fan 160 may pull ambient temperature air 180 from outside a rear end 104 of the alternator 100 in through the cover assembly 172, across the electronics 130, 140, and into the rear end housing 171. The electronics-heated air 180 may be expelled radially by the internal rear end fan 160 out the sides 106 of the alternator 100.

The internal drive end fan 150 may be disposed within the drive end housing 170 and coupled to the hollow and/or drive end poles 112 of the rotor assembly 110. The internal drive end fan 150 may therefore rotate with the spinning of the hollow and/or drive end poles 112. The internal drive end fan 150 may have a diameter that is larger than the diameter of a rotor assembly 110 of the alternator 100 to allow space to direct air toward the stator windings 120 and to increase air flow. The internal drive end fan 150 and/or a separate part adjacent to the internal drive end fan 150 may comprise a curved or angled outlet section to direct air to the stator windings 120 of the alternator 100. For example, the internal drive end fan 150 may provide a drive end fan air flow 190 that cools the stator windings 120 and is expelled out the side 106 of the alternator 100. The internal drive end fan 150 may pull ambient temperature air 190 from outside a drive end 102 of the alternator 100 in through the drive end housing 170. In various embodiments, the internal drive end fan 150 may by a centrifugal fan and the curved or angled outlet section provides an axial flow of air 190 across the stator windings 120. The air 190 heated by the stator windings 120 may then be expelled out the sides 106 of the alternator 100.

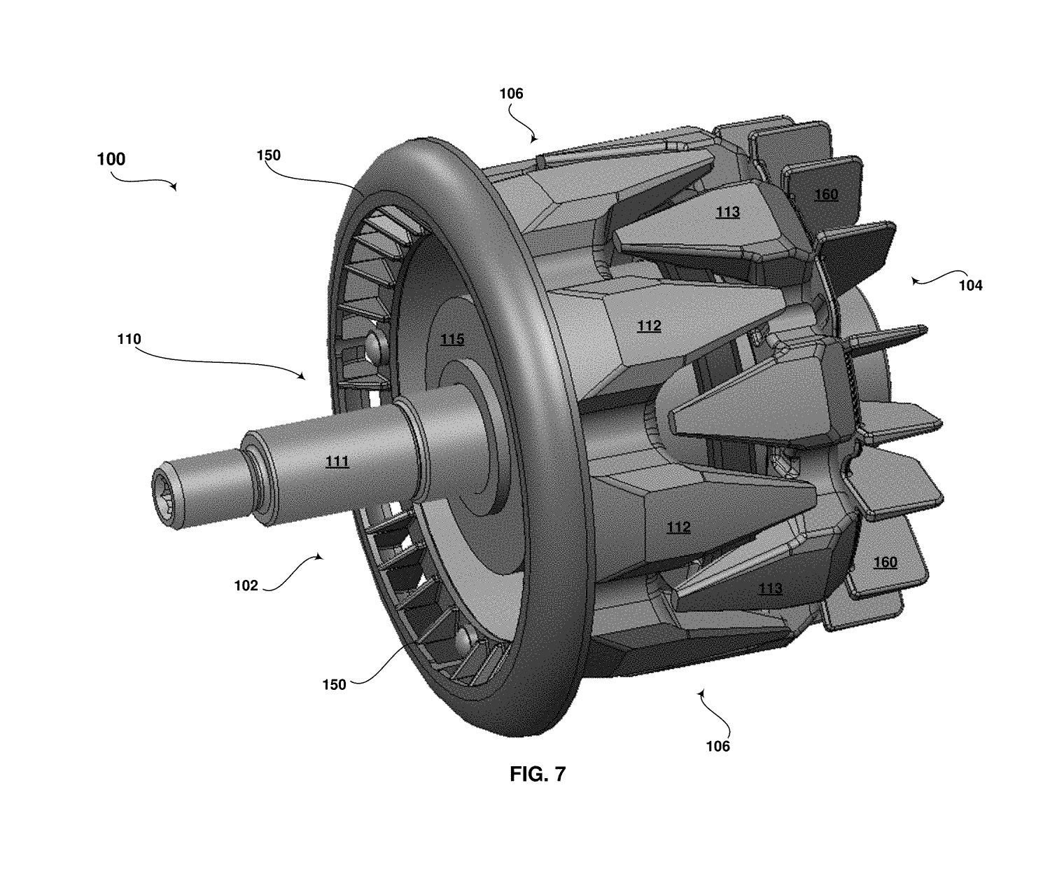

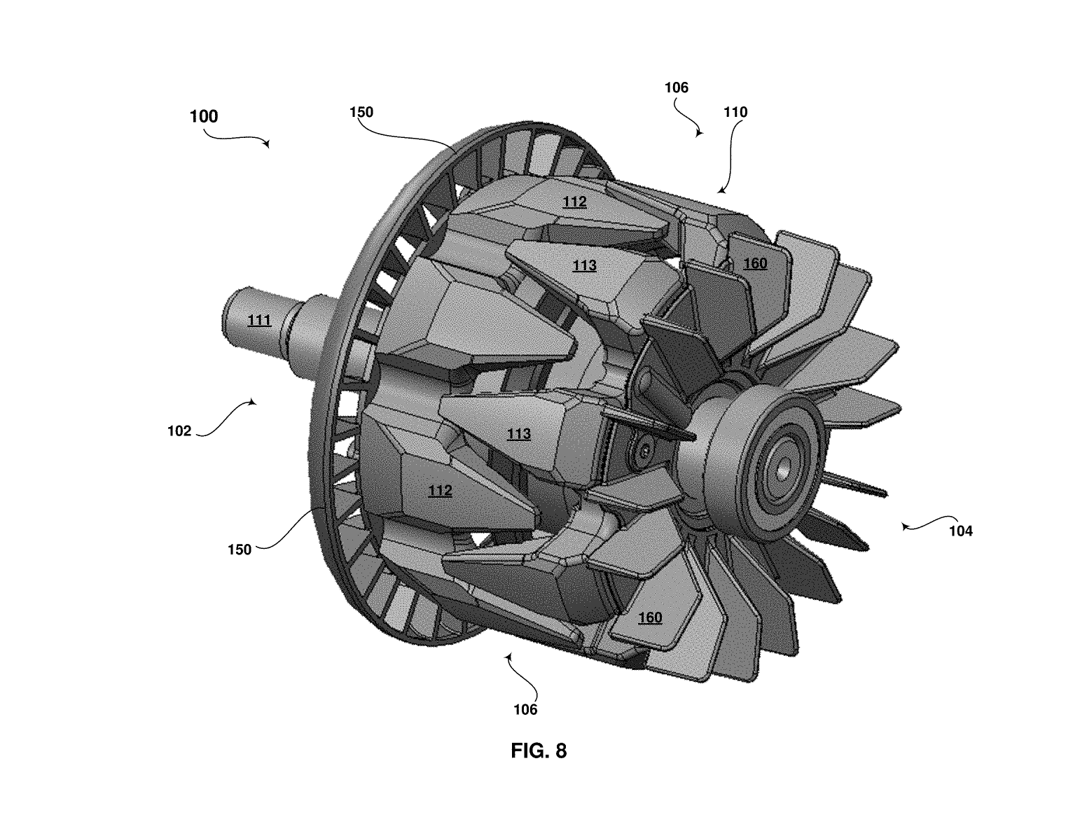

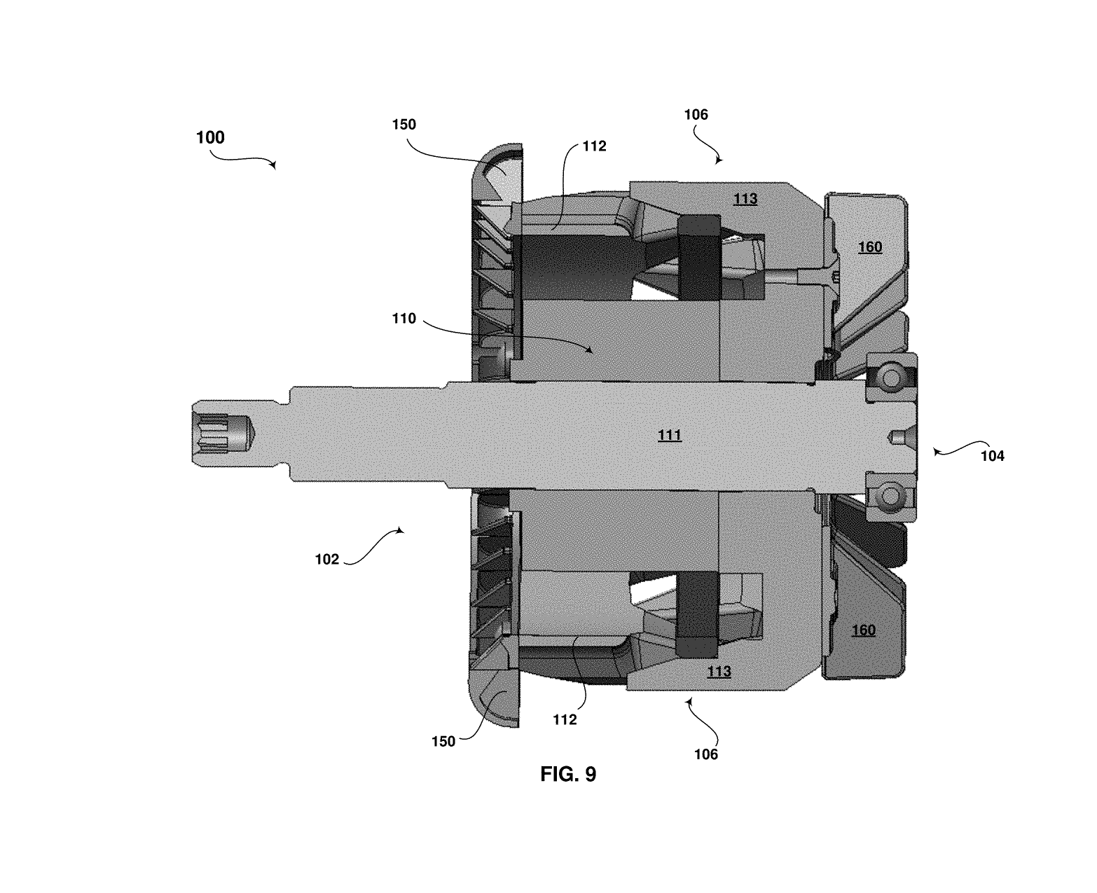

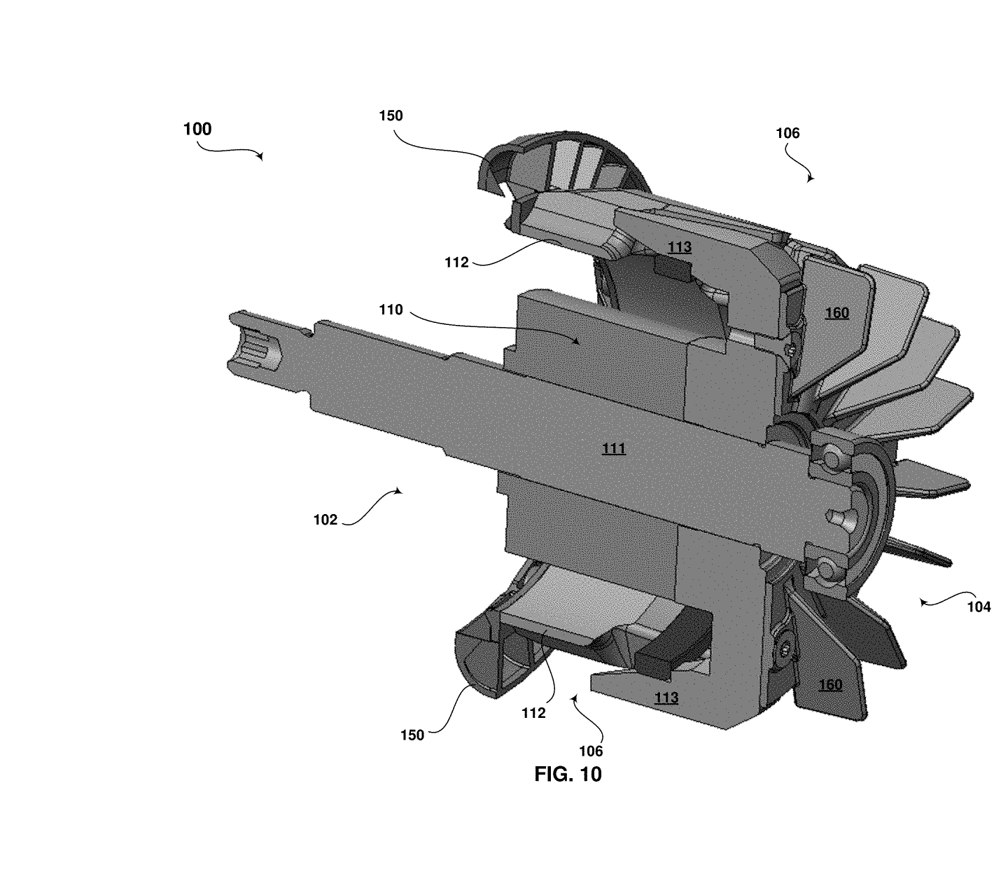

FIG. 7 is a front perspective view of a portion of an exemplary brushless alternator 100 comprising an internal fan 150 operable to cool stator windings (not shown) in accordance with various embodiments. FIG. 8 is a rear perspective view of a portion of an exemplary brushless alternator 100 comprising an internal fan 150 operable to cool stator windings (not shown) in accordance with various embodiments. FIG. 9 is a vertical cross-sectional view, taken along the longitudinal axis of a rotor assembly shaft 111, of a portion of an exemplary brushless alternator 100 comprising an internal fan 150 operable to cool stator windings (not shown) in accordance with various embodiments. FIG. 10 is a rear perspective, vertical cross-sectional view, taken along the longitudinal axis of a rotor assembly shaft 111, of a portion of an exemplary brushless alternator 100 comprising an internal fan 150 operable to cool stator windings (not shown) in accordance with various embodiments.

Referring to FIGS. 7-10, the exemplary alternator 100 may comprise a drive end 102, a rear end 104, sides 106, a rotor assembly 110, an internal drive end fan 150, and an internal rear end fan 160, among other things. The rotor assembly 110 may comprise drive end rotor poles 112 and rear end rotor poles 113 operable to rotate around a stationary bobbin core 115 wound with a field coil 114. The internal rear end fan 160 may be affixed to the solid and/or rear end rotor poles 113 of the rotor assembly 110. The internal drive end fan 150 may be affixed to the hollow and/or drive end rotor poles 112 of the rotor assembly 110. As illustrated in FIGS. 7-10, the diameter of the internal drive end fan 150 is larger than the diameter of the rotor assembly 110 made up of the rotor assembly shaft 111, field coil 114, bobbin core 115, and rotor poles 112, 113. In operation, the air pulled into the internal drive end fan 150 from the drive end 102 of the alternator 100 is blown out axially in the direction of the rear end 104 in the area outside of and surrounding the rotor poles 112, 113 based at least in part on the larger diameter of the internal drive end fan 150.

The exemplary alternator 100 illustrated in FIGS. 7-10 shares various characteristics with the exemplary alternator 100 illustrated in FIGS. 2-6 as described above.

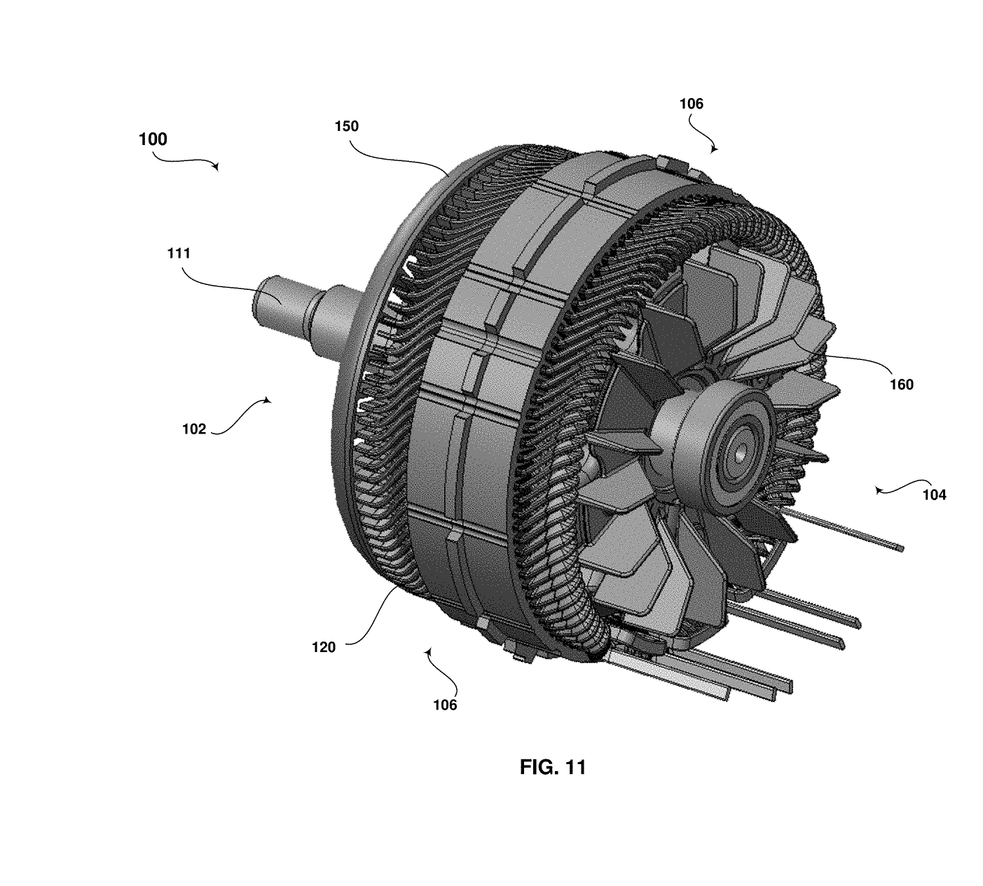

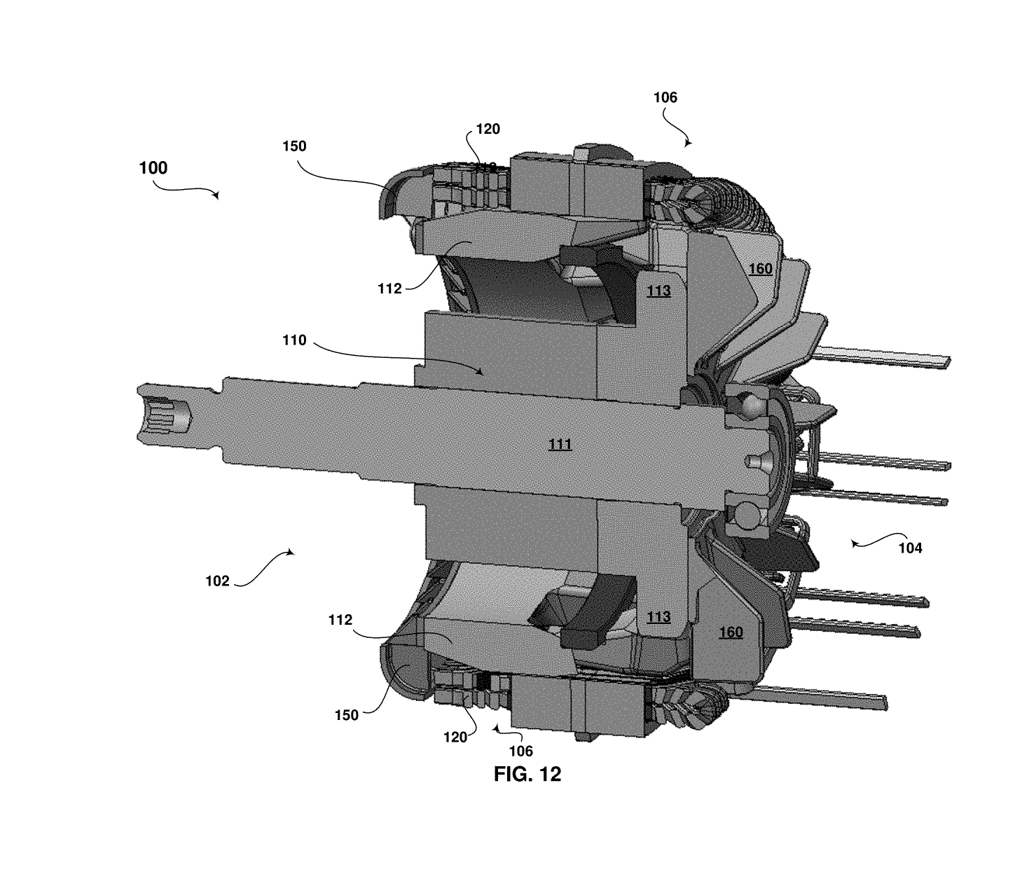

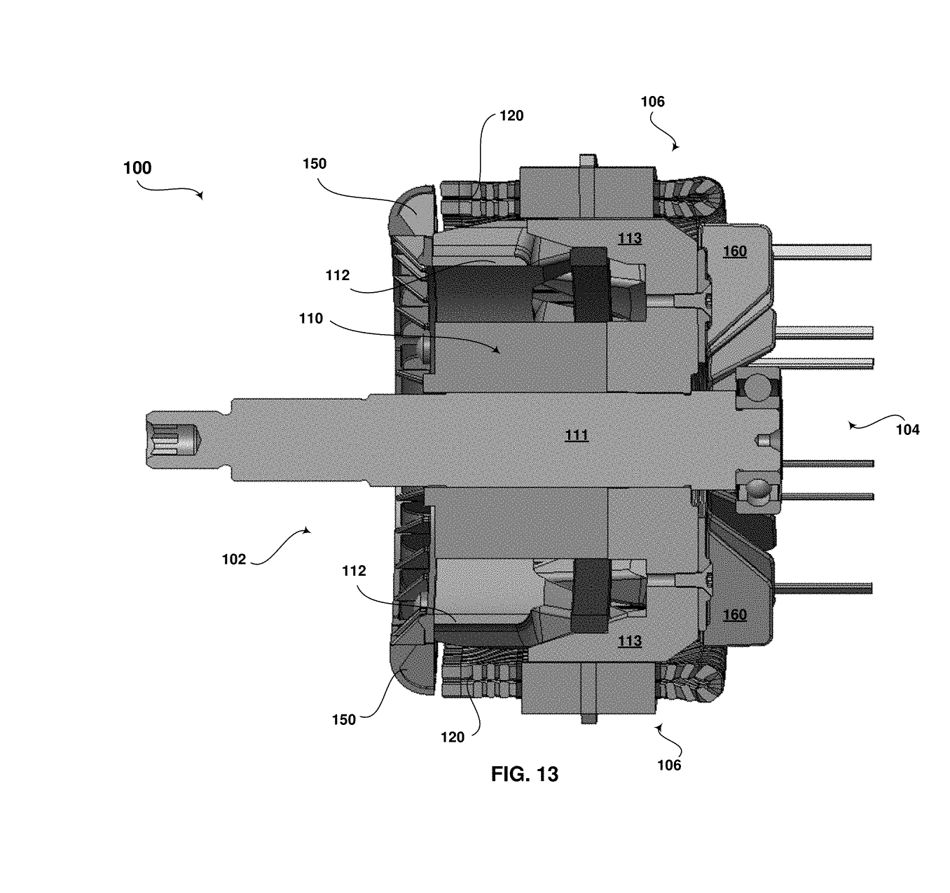

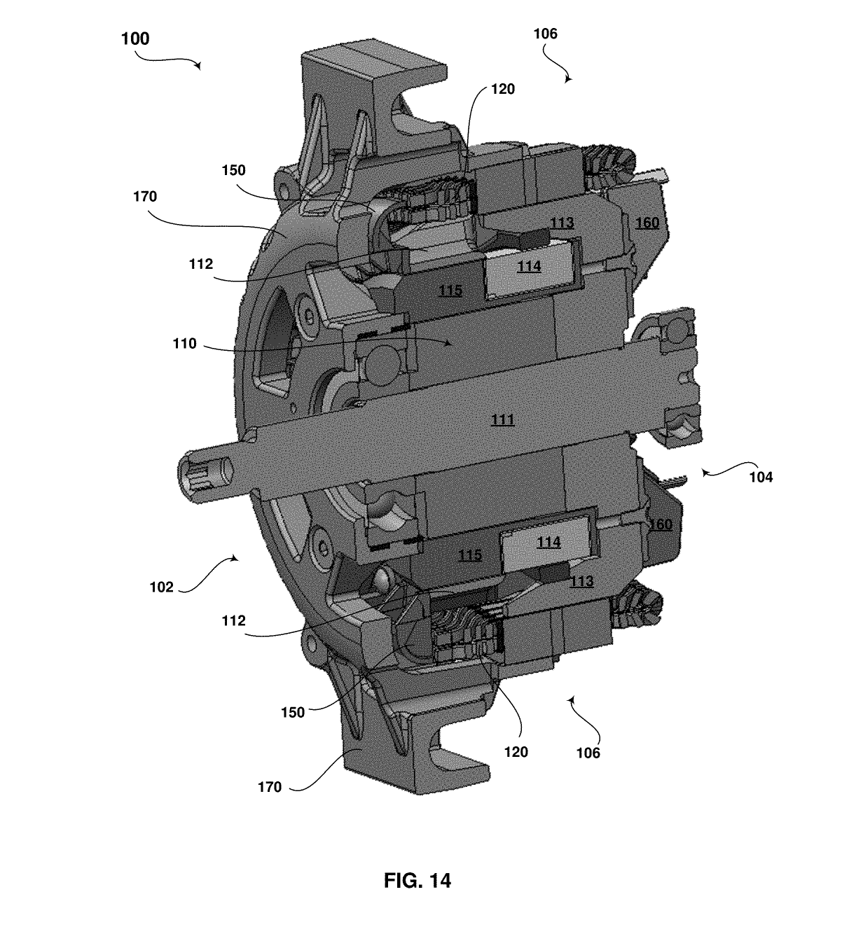

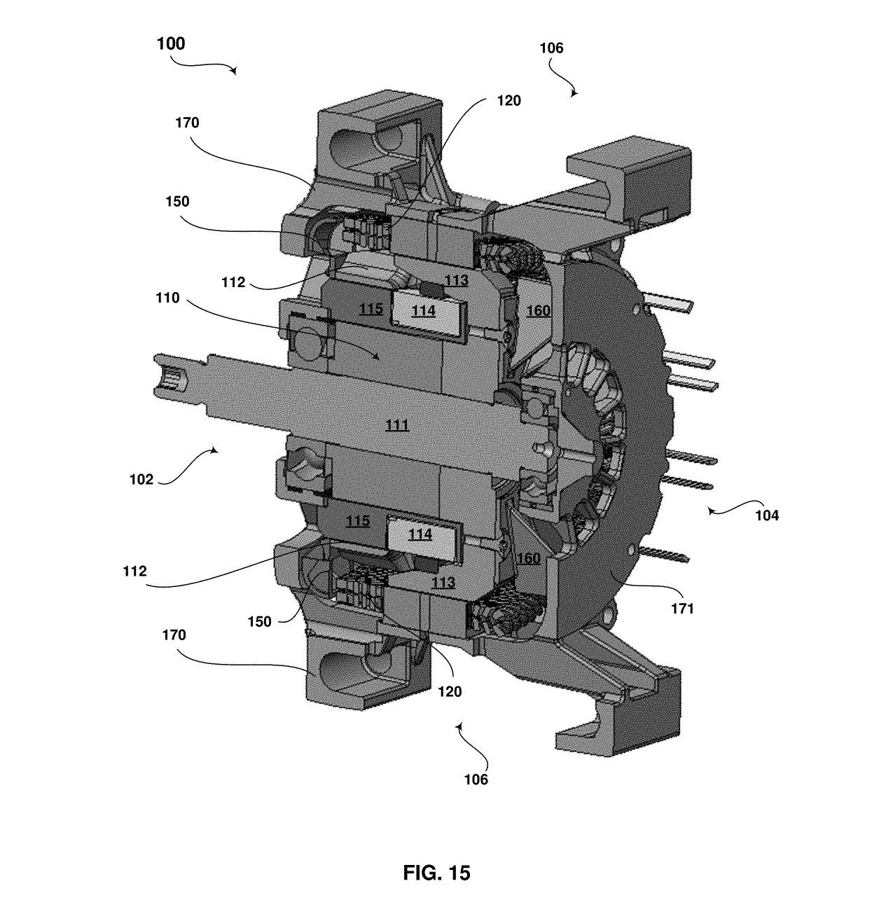

FIG. 11 is a rear perspective view of a portion of an exemplary brushless alternator 100 comprising an internal fan 150 operable to cool stator windings 120 in accordance with various embodiments. FIGS. 12 and 15 are rear perspective, vertical cross-sectional views, taken along the longitudinal axis of a rotor assembly shaft 111, of a portion of an exemplary brushless alternator 100 comprising an internal fan 150 operable to cool stator windings 120 in accordance with various embodiments. FIG. 13 is a vertical cross-sectional view, taken along the longitudinal axis of a rotor assembly shaft 111, of a portion of an exemplary brushless alternator 100 comprising an internal fan 150 operable to cool stator windings 120 in accordance with various embodiments. FIG. 14 is a front perspective, vertical cross-sectional view, taken along the longitudinal axis of a rotor assembly shaft 111, of a portion of an exemplary brushless alternator 100 comprising an internal fan 150 operable to cool stator windings 120 in accordance with various embodiments.

Referring to FIGS. 11-15, the exemplary alternator 100 may comprise a drive end 102, a rear end 104, sides 106, a rotor assembly 110, stator windings 120, an internal drive end fan 150, and an internal rear end fan 160, among other things. The rotor assembly 110 may comprise drive end rotor poles 112 and rear end rotor poles 113 operable to rotate around a stationary bobbin core 115 wound with a field coil 114. The stator windings 120 are a stationary component surrounding the rotor assembly 110. The drive end rotor poles 112, rear end rotor poles 113, and field coil 114 of the rotor assembly 110 induce an alternating voltage into the stator windings 120. The internal rear end fan 160 may be affixed to the solid and/or rear end rotor poles 113 of the rotor assembly 110. The internal drive end fan 150 may be affixed to the hollow and/or drive end rotor poles 112 of the rotor assembly 110. As illustrated in FIGS. 11-15, the diameter of the internal drive end fan 150 is larger than the diameter of the rotor assembly 110. Accordingly, air pulled into the internal drive end fan 150 from the drive end 102 of the alternator 100 is blown out axially at the stator windings 120 based at least in part on the larger diameter of the internal drive end fan 150.

The exemplary alternator 100 illustrated in FIGS. 11-15 shares various characteristics with the exemplary alternator 100 illustrated in FIGS. 2-10 as described above.

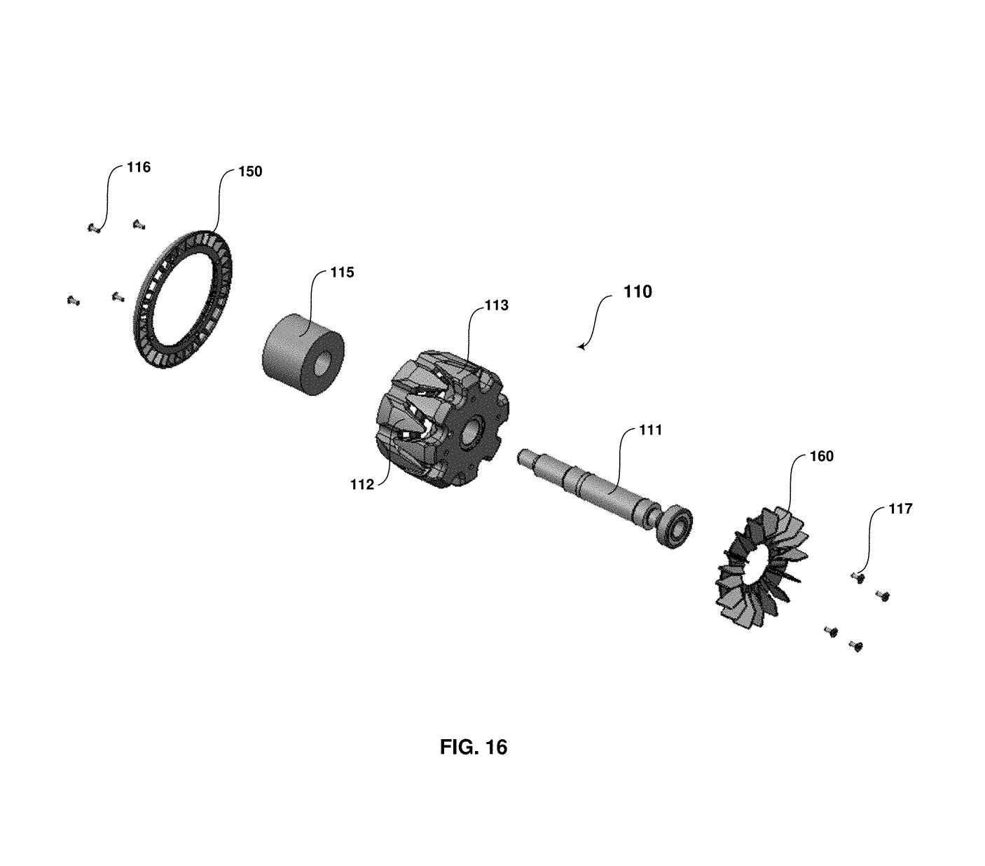

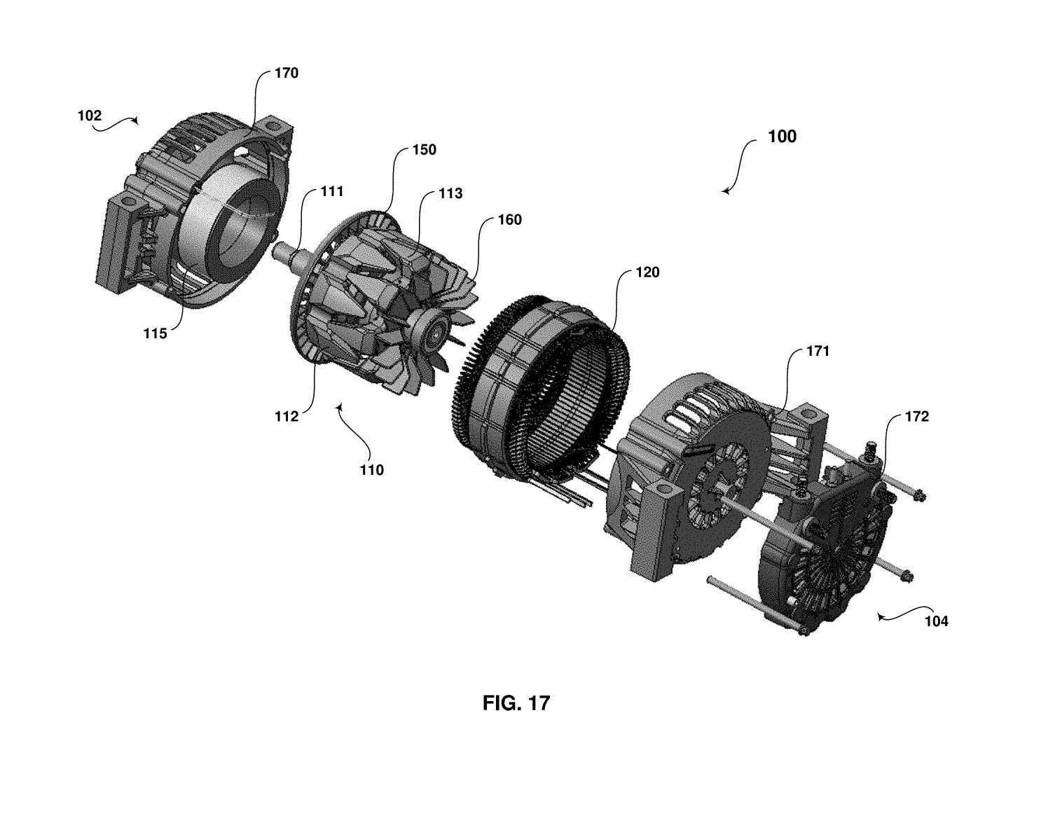

FIG. 16 is a partially exploded perspective view of a portion of an exemplary brushless alternator 100 comprising an internal fan 150 operable to cool stator windings (not shown) in accordance with various embodiments. FIG. 17 is a partially exploded perspective view of an exemplary brushless alternator 100 comprising an internal fan 150 operable to cool stator windings 120 in accordance with various embodiments. Referring to FIGS. 16-17, the alternator 100 may comprise a rotor assembly 110, an internal drive end fan 150, and an internal rear end fan 160, among other things. The rotor assembly 110 may comprise a rotor shaft 111, rotor poles 112, 113, and a bobbin core 115. The rotor shaft 111 may extend through the bobbin core 115 and rotor poles 112, 113. The rotor shaft 111 rotates to spin drive end rotor poles 112 and rear end rotor poles 113 surrounding the stationary bobbin core 115. The rotor poles 112, 113 can be a claw-pole configuration having a number of alternating pole fingers. The pole fingers may alternate between a drive end pole 112 and a rear end pole 113. The drive end poles 112 may be hollow poles and the rear end poles 113 may be solid poles, for example. The internal drive end fan 150 may be mounted to the hollow and/or drive end rotor poles 112 and the internal rear end fan 160 may be mounted to the solid and/or rear end rotor poles 113. For example, the internal fans 150, 160 may be mounted to the rotor poles 112, 113 by screws 116, 117, welding, rivets, or any suitable attachment mechanism.

Referring to FIG. 17, the alternator 100 may comprise a drive end 102, rear end 104, drive end housing 170, rear end housing 171, cover assembly 172, rotor assembly, 110, internal fans 150, 160, and stator windings 120, among other things. The cover assembly 172 may be attached to the rear end housing 171 and can be used to house electronics, such as regulator and rectifier assemblies. The rotor assembly 110, internal fans 150, 160 and stator windings 120 may be disposed within the drive end and rear end housings 170, 171. The internal fans 150, 160 may be coupled to the rotor poles 112, 113 of the rotor assembly 110. Stator windings 120 may surround the rotor poles 112, 113 of the rotor assembly 110. Referring again to FIGS. 16-17, the diameter of the internal drive end fan 150 is greater than the diameter of the rotor assembly 110 so that air expelled at the outer edge of the internal drive end fan 150 is directed across the stator windings 120 surrounding the rotor assembly 110.

The exemplary alternator 100 illustrated in FIGS. 16-17 shares various characteristics with the exemplary alternator 100 illustrated in FIGS. 2-15 as described above.

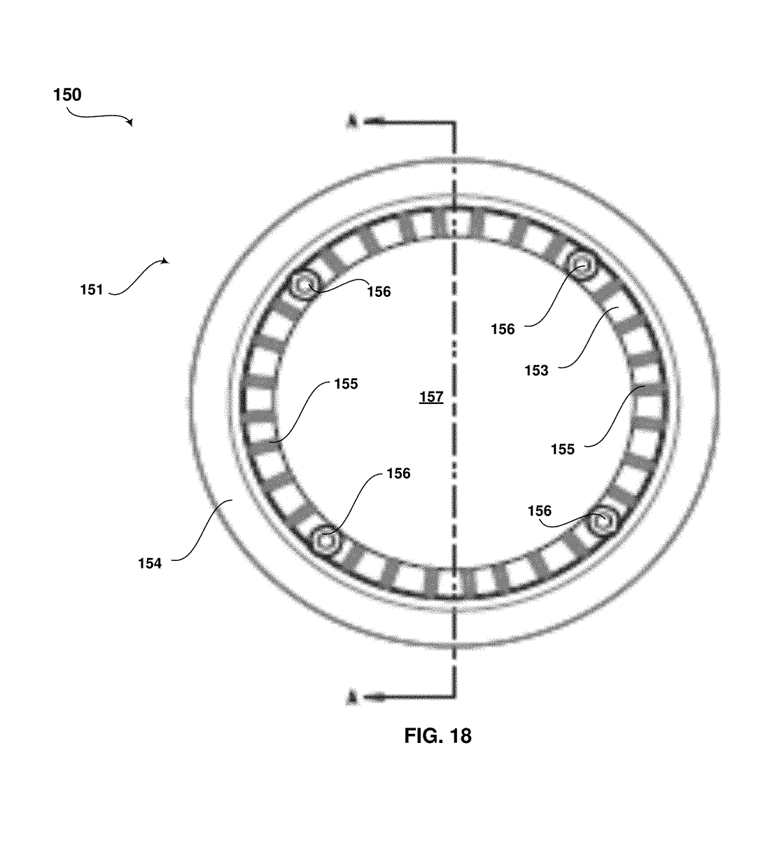

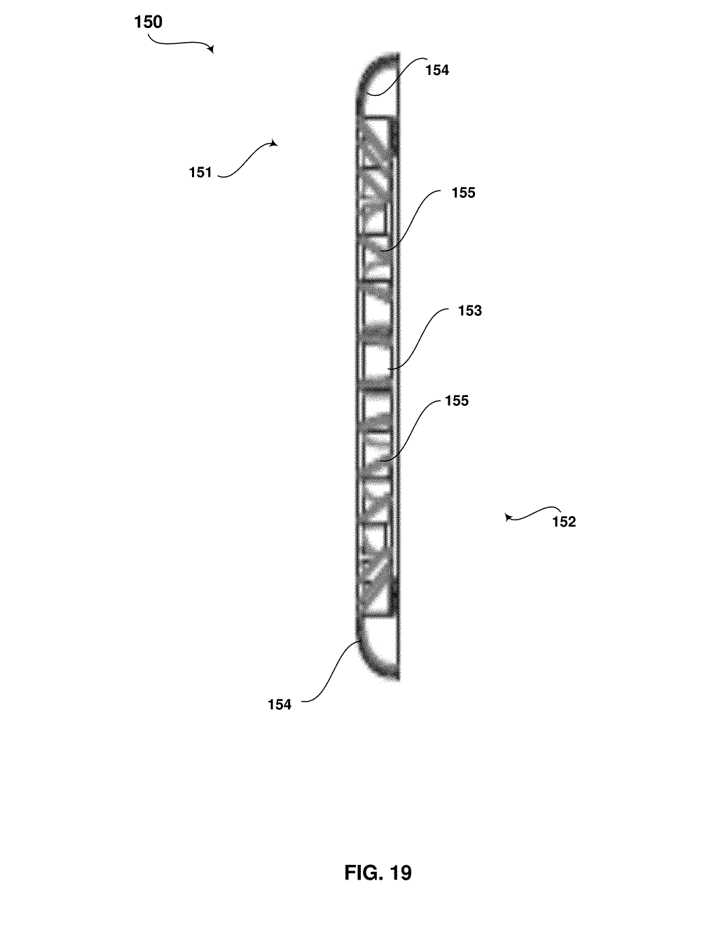

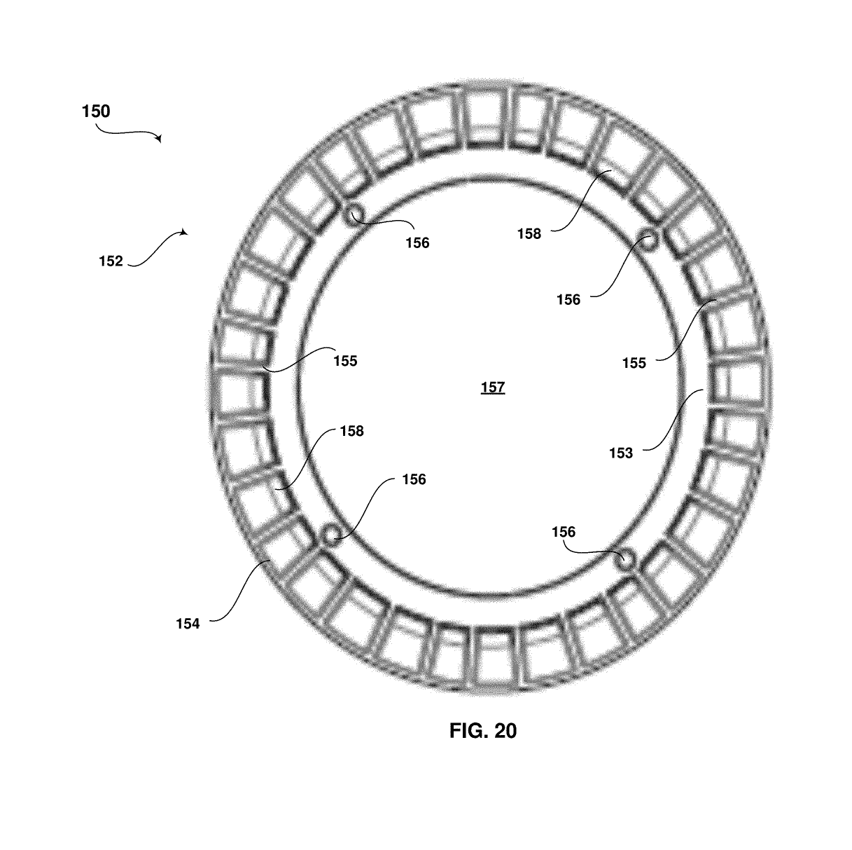

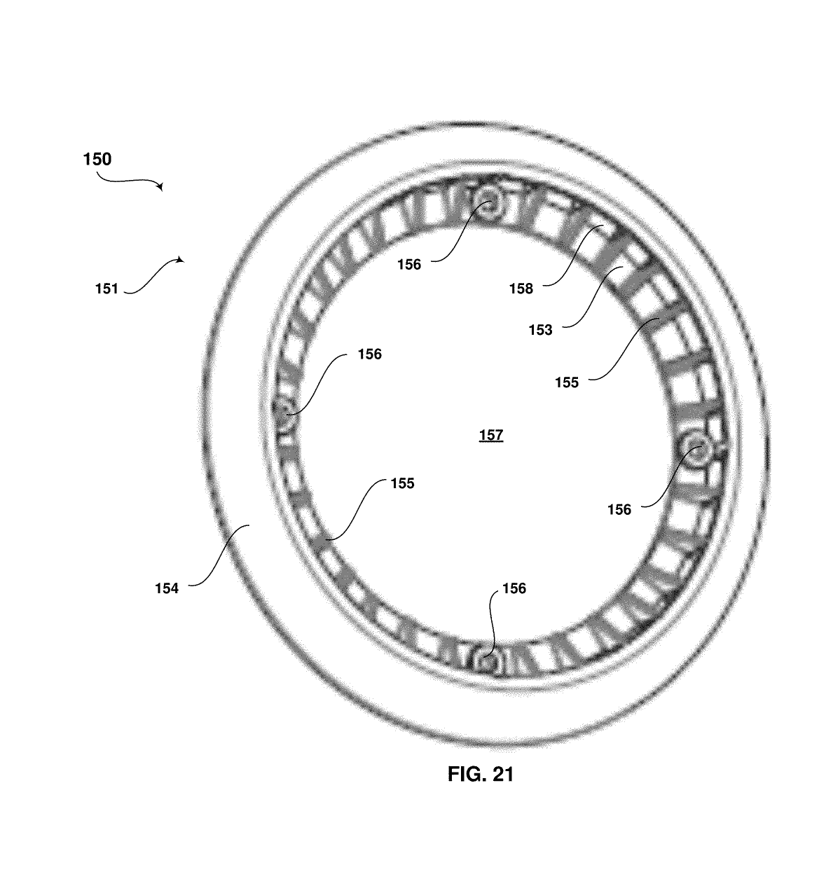

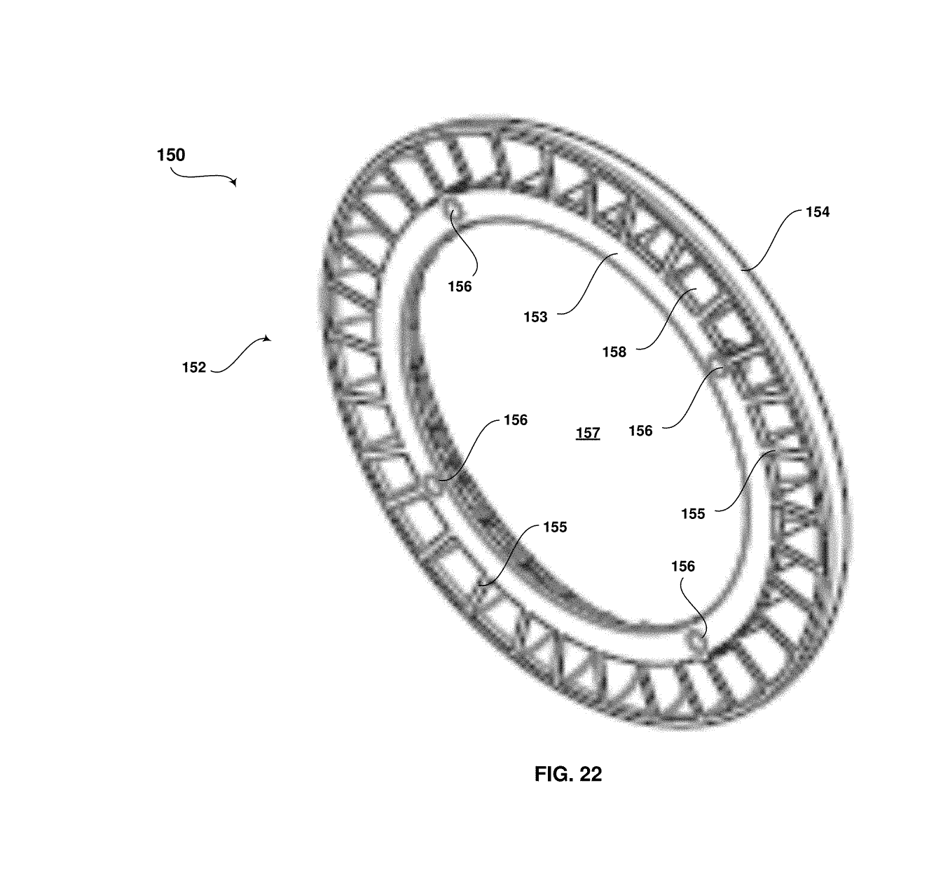

FIG. 18 illustrates a front end elevational view of an exemplary internal fan 150 in accordance with various embodiments. FIG. 19 illustrates a vertical cross-sectional view of an exemplary internal fan 150, taken along the longitudinal axis of the internal fan 150, in accordance with various embodiments. FIG. 20 illustrates a rear end elevational view of an exemplary internal fan 150 in accordance with various embodiments. FIG. 21 illustrates a front end perspective view of an exemplary internal fan 150 in accordance with various embodiments. FIG. 22 illustrates a rear end perspective view of an exemplary internal fan 150 in accordance with various embodiments. Referring to FIGS. 18-22, the internal fan 150 may comprise an inlet side 151, an outlet side 152, an inner portion 153, an outer portion 154, fan blades 155, mounting holes 156, a center opening 157, and air flow openings 158, among other things. The inner portion 153 and outer portion 154 may be generally circular walls that define the center opening 157. The inner portion 153 may include mounting holes 156 for attaching the internal fan 150 to rotor poles of a rotor assembly of an alternator, for example.

The inlet side 151 of the inner portion 153 may be connected to the outlet side 152 of the outer portion 154 by a plurality of fan blades 155. The gap between the inner potion 153 and outer portion 154 between each of the fan blades 155 may define air flow openings 158. In various embodiments, the inlet side 151 of the outer portion 154 may be generally convex-shaped or otherwise angled and the outlet side 152 of the outer portion 154 may be generally concave-shaped or otherwise angled to direct the air flow axially from the outlet side 152 of the outer portion 154. The fan blades 155 may extend into the generally concave-shaped or otherwise angled surface of the outlet side 152 of the outer portion 154.

The internal fan 150 may be a centrifugal fan configured to accelerate air radially out along the generally concave-shaped or otherwise angled surface of the outlet side 152 of the outer portion 154 and between the fan blades 155. In operation, as the internal fan 150 rotates, air is pulled by the fan blades 155 from the inlet side 151 through the air flow openings 158 radially across the surface on the outlet side 152 of the outer portion 154. The curved or angled shape of the outlet side 152 of the outer portion 154 causes the internal fan 150 to axially blow the air out of the internal fan 150.

The exemplary internal fan 150 illustrated in FIGS. 18-22 shares various characteristics with the exemplary internal fan 150 illustrated in FIGS. 2-17 as described above.

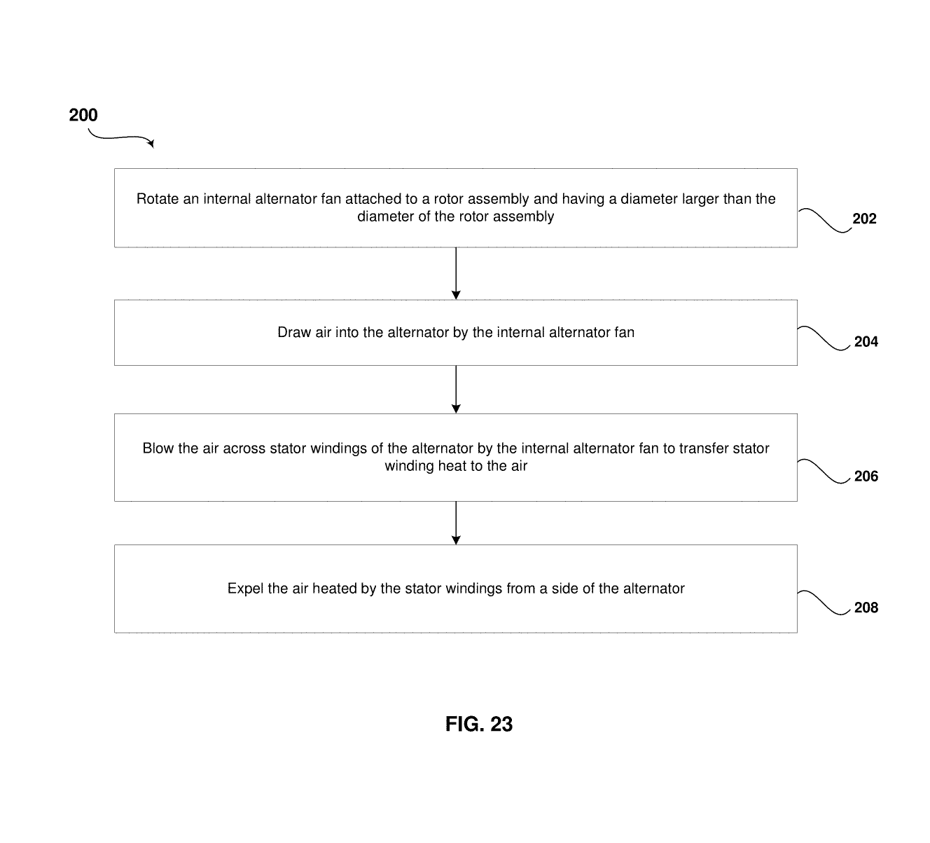

FIG. 23 is a flow diagram 200 that illustrates exemplary steps 202-208 for cooling stator windings 120 with an internal fan 150 of a brushless alternator 100 in accordance with various embodiments. Referring to FIG. 23, there is shown a flow chart 200 comprising exemplary steps 202 through 208. Certain embodiments of the present disclosure may omit one or more of the steps, and/or perform the steps in a different order than the order listed, and/or combine certain of the steps discussed below. For example, some steps may not be performed in certain embodiments. As a further example, certain steps may be performed in a different temporal order than listed below, including but not limited to simultaneously. Although the method is described with reference to the exemplary elements of the systems described above, it should be understood that other implementations are possible.

At step 202, an internal alternator fan 150 attached to a rotor assembly 110 and having a diameter larger than the diameter of the rotor assembly 110 is rotated. In certain embodiments, the internal fan 150 may be the fan 150 described with reference to FIGS. 2-22, or any suitable internal alternator fan 150. For example, the internal alternator fan 150 may comprise an inner portion 153 and an outer portion 154 that are circular walls defining a center opening 157. An inlet side 151 of the inner portion 153 may be connected to an outlet side 152 of the outer portion 154 by fan blades 155 to form air flow openings 158 between the inner portion 153 and the outer portion 154 and between the fan blades 155. The inner portion 153 of the internal alternator fan 150 may be mounted to rotor poles 112 of a rotor assembly 110 of the alternator 100 so that the internal alternator fan 150 rotates with the rotation of the rotor poles 112. The outer diameter of the internal alternator fan 150 may have a diameter that is larger than the outer diameter of the rotor assembly 110. The rotor shaft 111 of the rotor assembly 110 may extend through the center opening 157 of the alternator fan 150. The rotor poles 112 are driven to rotate by the rotor shaft 111 connected with, for instance, a pulley that may be driven by the engine of a motor vehicle, not shown.

At step 204, ambient temperature air is drawn into the alternator 100 by the internal alternator fan 150. For example, the rotation of the internal alternator fan 150 may cause the fan blades 155 to pull air into the drive end 102 of the alternator 100 through inlets in the drive end housing 170. The air flow 190 drawn into the alternator 100 may be pulled through the air flow openings 158 and accelerated radially out along the outlet side 152 of the outer portion 154 and between the fan blades 155.

At step 206, the air flow 190 generated by the internal alternator fan 150 may be blown across stator windings 120 of the alternator 100 to transfer heat from the stator windings 120 to the air flow 190. For example, the outlet side 152 of the outer portion 154 may have a surface that is generally concave-shaped or otherwise angled to direct the air flow 190 out axially from the internal alternator fan 150. Additionally and/or alternatively, the air flow 190 blown from the internal alternator fan 150 may be redirected by a curved or angled surface piece that is one or more of attached to or integrated with an internal portion of a housing 170, 171 of the alternator 100 adjacent to the internal alternator fan 150. The rotation of the internal alternator fan 150 may cause the fan blades 155 to blow the air flow 190 axially from the outlet side 152 of the outer portion 154 of the internal alternator fan 150. The air flow 190 output from the internal alternator fan 150 may be blown over the stator windings 120 of the alternator 100 to transfer the heat from the stator windings 120 to the air flow 190. For example, the larger diameter of the internal alternator fan 150 relative to the diameter of the rotor assembly 110 allows the air flow 190 output from the internal alternator fan 150 to be blown directly across stator windings 120 surrounding the rotor assembly 110. The transfer of the heat from the stator windings 120 may cool the stator windings 120 to enhance the performance and life of the alternator 100.

At step 208, the air flow 190 heated by the stator windings 120 is expelled from a side 106 of the alternator 100. For example, the alternator 100 may comprise outlets at the sides 106 of housing(s) 170, 171. The air flow 190 heated by the stator windings 120 at step 206 may be expelled out the outlets at the sides 106 of housing(s) 170, 171 at step 208.

Various embodiments provide a brushless alternator 100 comprising a drive end 102, a rear end 104, a rotor assembly 110, stator windings 120, and an internal fan 150. The rotor assembly 110 may be between the drive end 102 and the rear end 104 of the alternator 100. The rotor assembly 110 may have a first diameter. The rotor assembly 110 may comprise a hollow pole 112 and a solid pole 113. The stator windings 120 may surround the rotor assembly 110. The internal fan 150 may have a second diameter that is larger than the first diameter of the rotor assembly 110. The large diameter of the internal fan 150 provides increased air flow 190 and provides space to direct the air flow 190 toward the stator windings 120. The internal fan 150 may be attached to the hollow pole 112 of the rotor assembly 110.

In certain embodiments, the internal fan 150 may be welded, screwed 116, riveted, or the like to the hollow pole 112. In various embodiments, the internal fan 150 may be aluminum, plastic, steel, or any suitable material. In a representative embodiment, the internal fan comprises an outer portion 154 shaped to direct air flow 190 at the stator windings 120. In various embodiments, the outer portion 154 of the internal fan 150 comprises one or more of a curved or angled surface to direct the air flow 190. In certain embodiments, the internal fan 150 provides an axial flow of the air flow 190 directed to the stator windings 120. In a representative embodiment, the hollow pole 112 is positioned toward the drive end 102 and the solid pole 113 is positioned toward the rear end 104. In various embodiments, the brushless alternator 100 comprises a housing 170, 171. In certain embodiments, a curved or angled surface piece is one or more of attached to or integrated with an internal portion of the housing 170, 171 adjacent to the internal fan 150 to direct air flow 190 from the internal fan 150.

In a representative embodiment, the internal fan 150 comprises an inner portion 153 and an outer portion 154. The inner portion 153 and the outer portion 154 may be generally circular walls defining a central opening 157. In various embodiments, each of the inner portion 153 and the outer portion 154 may comprise an inlet side 151 and an outlet side 152. The inlet side 151 of the inner portion 153 may be connected to the outlet side 152 of the outer portion 154 by a plurality of fan blades 155. In certain embodiments, air flow openings 158 may be defined between the plurality of fan blades 155. In a representative embodiment, the inner portion 153 may comprise mounting holes 156 for attaching the internal fan 150 to the hollow pole 112 of the rotor assembly 110.

Aspects of the present disclosure provide a method 200 for cooling stator windings 120 of a brushless alternator 100. The method may comprise rotating 202 an internal fan 150 attached to a hollow pole 112 of a rotor assembly 110. The internal fan 150 may have a diameter that is larger than a diameter of the rotor assembly 110. The method 200 may comprise drawing 204 air flow 190 into the brushless alternator 100 by the internal fan 150. The method 200 may comprise blowing 206, via the internal fan 150, the air flow 190 across the stator windings 120 to transfer stator winding heat to the air flow 190. The internal fan 150 may be shaped to direct the air flow 190 at the stator windings 120. The method 200 may comprise expelling 208 the stator winding-heated air flow 190 from a side 106 of the brushless alternator 100.

In various embodiments, the internal fan 150 may be shaped by an outer portion 154 comprising one or more of a curved or angled surface to direct the air flow 190. In a representative embodiment, blowing 206 the air flow 190 across the stator windings 120 may be an axial flow of the air flow 190 blown by the internal fan 150. In certain embodiments, the air flow 190 blown from the internal fan 150 may be directed by a curved or angled surface piece that is one or more of attached to or integrated with an internal portion of a housing 170, 171 of the brushless alternator 100 adjacent to the internal fan 150. In various embodiments, the internal fan 150 may be attached to the hollow pole 112 at the drive end 102 of the rotor assembly 110. In a representative embodiment, the air flow 190 may be drawn by the internal fan 150 through a drive end 102 of the brushless alternator 100.

In certain embodiments, the internal fan 150 comprises an inner portion 153 and an outer portion 154. The inner portion 153 and the outer portion 154 may be generally circular walls defining a central opening 157. In various embodiments, each of the inner portion 153 and the outer portion 154 may comprise an inlet side 151 and an outlet side 152. The inlet side 151 of the inner portion 153 may be connected to the outlet side 152 of the outer portion 154 by a plurality of fan blades 155. In certain embodiments, air flow openings 158 may be defined between the plurality of fan blades 155. In a representative embodiment, the inner portion 153 may comprise mounting holes 156 for attaching the internal fan 150 to the hollow pole 112 of the rotor assembly 110.

As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.” and “for example” set off lists of one or more non-limiting examples, instances, or illustrations.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A brushless alternator comprising:
a drive end;
a rear end;
a rotor assembly between the drive end and the rear end, the rotor assembly having a first diameter, the rotor assembly comprising a hollow pole and a solid pole;
stator windings surrounding the rotor assembly; and
an internal fan having a second diameter that is larger than the first diameter of the rotor assembly, the internal fan attached to the hollow pole of the rotor assembly.

2. The brushless alternator according to claim 1, wherein the internal fan comprises an outer portion shaped to direct air flow at the stator windings.

3. The brushless alternator according to claim 2, wherein the outer portion of the internal fan comprises one or more of a curved or angled surface to direct the air flow.

4. The brushless alternator according to claim 2, wherein the internal fan provides an axial flow of the air flow directed to the stator windings.

5. The brushless alternator according to claim 1, wherein the hollow pole is positioned toward the drive end and the solid pole is positioned toward the rear end.

6. The brushless alternator according to claim 1, comprising a housing, wherein a curved or angled surface piece is one or more of attached to or integrated with an internal portion of the housing adjacent to the internal fan to direct air flow from the internal fan.

7. The brushless alternator according to claim 1, wherein the internal fan comprises an inner portion and an outer portion, and wherein the inner portion and the outer portion are generally circular walls defining a central opening.

8. The brushless alternator according to claim 7, wherein each of the inner portion and the outer portion comprises an inlet side and an outlet side, the inlet side of the inner portion connected to the outlet side of the outer portion by a plurality of fan blades.

9. The brushless alternator according to claim 8, wherein air flow openings are defined between the plurality of fan blades.

10. The brushless alternator according to claim 8, wherein the inner portion comprises mounting holes for attaching the internal fan to the hollow pole of the rotor assembly.

11. A method for cooling stator windings of a brushless alternator, the method comprising:
rotating an internal fan attached to a hollow pole of a rotor assembly, the internal fan having a diameter that is larger than a diameter of the rotor assembly;
drawing air flow into the brushless alternator by the internal fan;
blowing, via the internal fan, the air flow across the stator windings to transfer stator winding heat to the air flow, wherein the internal fan is shaped to direct the air flow at the stator windings; and
expelling the stator winding-heated air flow from a side of the brushless alternator.

12. The method of claim 11, wherein the internal fan is shaped by an outer portion comprising one or more of a curved or angled surface to direct the air flow.

13. The method of claim 11, wherein the blowing the air flow across the stator windings is an axial flow of the air flow blown by the internal fan.

14. The method of claim 11, wherein the air flow blown from the internal fan is directed by a curved or angled surface piece that is one or more of attached to or integrated with an internal portion of a housing of the brushless alternator adjacent to the internal fan.

15. The method of claim 11, wherein the internal fan is attached to the hollow pole at the drive end of the rotor assembly.

16. The method of claim 11, wherein the air flow is drawn by the internal fan through a drive end of the brushless alternator.

17. The method of claim 11, wherein the internal fan comprises an inner portion and an outer portion, and wherein the inner portion and the outer portion are generally circular walls defining a central opening.

18. The method of claim 17, wherein each of the inner portion and the outer portion comprises an inlet side and an outlet side, the inlet side of the inner portion connected to the outlet side of the outer portion by a plurality of fan blades.

19. The method of claim 18, wherein air flow openings are defined between the plurality of fan blades.

20. The method of claim 18, wherein the inner portion comprises mounting holes for attaching the internal fan to the hollow pole of the rotor assembly.
